(19) United States
(12) Patent Application Publication
(10) Pub. No.: US 2006/0179443 A1
(43) Pub. Date: Aug. 10, 2006

(54) Tray-equipped recording/reproducing apparatus

(75) Inventors: Toshimitsu Koyama, Echizen-shi (JP); Masakuni Kobashi, Echizen-shi (JP); Hikari Okumura, Echizen-shi (JP); Takuya Sasaki, Echizen-shi (JP); Kenji Kishizuka, Echizen-shi (JP)

Correspondence Address: REED SMITH LLP, Suite 1400, 3110 Fairview Park Drive, Falls Church, VA, 22042, US

(73) Assignee: Orion Electric Company Ltd.

(21) Appl. No.: 11/338,719

(22) Filed: Jan. 25, 2006

(30) Foreign Application Priority Data
Feb. 10, 2005 (JP) 2005-034099

(51) Int. Cl. G11B 17/04; G11B 33/02; G11B 17/03

(52) U.S. Cl. 720/601; 720/647

(57) ABSTRACT

There is provided a recording/reproducing apparatus having a simple and inexpensive structure of providing a protrusion at a front side end of a tray for placing a storage medium and transporting the storage medium inside and outside of the recording/reproducing apparatus; providing an engaging rib at the rear side of an open/close door mounted on a casing, the door pivotably opening and closing together with reciprocating movement of the tray; the protrusion and the engaging rib being engaged with each other when the open/close door is in a closed state, and thereby the closed state of the open/close door can be maintained in response to a stress which acts in a direction in which the open/close door is opened from the outside of the recording/reproducing apparatus.

### BACKGROUND OF THE INVENTION

1. Field of the Invention

The present invention relates to a recording/reproducing apparatus for carrying out storage and/or reproduction of a storage medium such as a DVD. In particular, the present invention relates to a recording/reproducing apparatus including a tray for transporting a storage medium between a storage and/or reproduction position inside of the apparatus and a storage medium exchange position outside of the apparatus and an door which opens and closes together with a transporting operation of the tray at an opening portion of a casing formed on a transport passage of this tray.

2. Description of the Related Art

Conventionally, with respect to a door for opening and closing an opening portion of a recording/reproducing apparatus, in order to read out and reproduce information contained in a storage medium and/or to record information in the storage medium, there have been proposed a number of structures for preventing entry of foreign matter from the open/close door in a state in which the storage medium is set at the storage and/or reproduction position inside of the recording/reproducing apparatus. However, the conventional proposals require an expensive door lock mechanism and a complicated structure. Therefore, there has been often a problem associated with cost efficiency.

In order to solve the above-described problem, in Japanese Utility Model Registration 3069866, there is disclosed a structure in which an engagement piece integrally formed at a side part of a tray for carrying and transporting a storage medium abuts against a pin provided at an end part of an arm which is turnable together with an open/close door of an opening portion, and, when the open/close door is in a closed state, the pin is fitted into a groove formed at the engagement piece, and is engaged with the engagement piece, and thereby, even if an external stress is applied, the door is maintained in the closed state. That is, there is disclosed a recording/reproducing apparatus having a comparatively simple, inexpensive structure in which the arm which turns together with the open/close door and the engagement piece integrally formed at the side part of the tray are merely provided without requiring an expensive door lock mechanism or the like, and thereby, in the case of a state in which the storage medium is at the storage and/or reproduction position inside of the recording/reproducing apparatus, i.e., in the case where the open/close door is in the closed state, it is possible to prevent an unexpected situation such as entry of foreign matter from the outside due to opening of the open/close door by the external stress.

Further, in Japanese Patent Application Laid-open No. 2002-334566, there is disclosed a structure in which a spring is wound around a support shaft provided at an open/close door, and thereby the open/close door is always biased in a closed direction, and the tray causes the open/close door to be pushed and opened against the spring by utilizing energy generated when the tray advances from the inside of the casing to the outside of the casing. That is, there is disclosed a recording/reproducing apparatus with a further simple and inexpensive structure which eliminates the arm which turns together with the open/close door which has been an indispensable part in the structure disclosed in Japanese Utility Model Registration 3069866.

The conventional problem with entry of foreign matter from the outside when the open/close door is in a closed state has been overcome by the structure disclosed in Japanese Utility Model Registration 3069866. However, in the structure, the number of parts such as the arm which turns together with the open/close door and the shaft for turning the arm is increased. Further, there is a need for a complicate mechanism for enabling a fine operation for guiding the arm along the engagement piece formed at the side part of the tray together with movement of the open/close door so that the pin provided at the end part of the arm is fitted into the groove formed at the engagement piece when the open/close door is in the closed state. Thus, it is unavoidable to increase cost due to an increased number of parts and an increased number of assembling steps. Further, there is a need for a complicated mechanism associated with a fine operation as described above, and thus, there is an apprehension that product service life is reduced due to repetition of reciprocating movement of the tray. In addition, in the structure disclosed in Japanese Utility Model Registration 3069866, at the time of the reciprocating movement of the tray which carries a storage medium, there is no structure for guiding the tray. Thus, vibration or rocking caused by the reciprocating movement of the tray is likely to occur, and product quality may be degraded.

According to Japanese Patent Application Laid-open No. 2002-334566, there is disclosed a recording/reproducing apparatus having a very simple and inexpensive structure in which there is no need for providing such a complicated structure as described in Japanese Utility Model Registration 3069866, and the closed state of the open/close door can be maintained by a spring for always biasing the open/close door in the closed state. However, with the structure disclosed in Japanese Patent Application Laid-open No. 2002-334566, when the open/close door is in the closed state, the open/close door can be easily opened by an external stress, for example, by manual operation, which exceeds the biasing force caused by the spring. Therefore, there is a danger that contact with a movable section of the recording/reproducing apparatus is made by entry of foreign matter from the outside or by children inserting his or her fingers into the door.

### SUMMARY OF THE INVENTION

The present invention has been made in order to solve the above-described problem. It is an object of the present invention to provide a tray-equipped recording/reproducing apparatus having a simple and inexpensive structure, the apparatus being capable of preventing entry of foreign matter from an opening portion of a casing formed on a transport passage of the tray.

In order to solve the above-described problems, the present invention provides a tray-equipped recording/reproducing apparatus comprising: a tray for transporting a storage medium between a storage and/or reproduction position inside of the apparatus and a storage medium exchange position outside of the apparatus; a casing having an opening portion on a transport passage of the tray; and an open/close door pivotably provided at the opening portion of the casing, the open/close door enabled to open or shut together with the transporting operation of the tray, wherein engagement means engaged with an outward end of the tray is provided at a rear side of the open/close door. Further, the present invention provides a tray-equipped recording/reproducing apparatus, wherein, at the front side end of the tray, a protrusion engaged with the engagement means of the open/close door is formed to be protruded in a widthwise direction of the tray. Further, the present invention provides a tray-equipped recording/reproducing apparatus, wherein, at a side end of the tray, a guide groove for guiding the engagement means of the open/close door together with the transporting operation of the tray is formed in the transport direction of the tray. Further, the present invention provides a tray-equipped recording/reproducing apparatus, wherein the engagement means of the open/close door is constructed to integrally form a support portion which extends from the rear face of the open/close door and a claw portion protruded inwardly of the open/close door from a tip end of the support portion. Further, the present invention provides a tray-equipped recording/reproducing apparatus, wherein, in a state in which the tray is transported to the storage and/or reproduction position inside the apparatus, the tray and the engagement means provided at the open/close door are engaged with each other to restrict an opening operation of the open/close door.

According to the present invention, there can be provided a recording/reproducing apparatus having a simple and inexpensive structure in which, when an open/close door mounted on a casing which pivotably opens and closes together with a reciprocating movement of a tray for transporting a storage medium such as a DVD is in a closed state, and the storage medium is at a storage and/or reproduction position inside of the recording/reproducing apparatus, engagement means provided at the rear side of the open/close door is engaged with a protrusion provided at a front side end of the tray, and thereby the closed state of the open/close door can be maintained against a stress which acts in a direction in which the open/close door is opened from the outside of the recording/reproducing apparatus.

### BRIEF DESCRIPTION OF THE DRAWINGS

FIG. 1 is a perspective view of a tray and an open/close door which configure a recording/reproducing apparatus according to an embodiment of the present invention;

FIG. 2 is a perspective view showing a state in which the open/close door is engagingly fitted to a side face stepped portion of the tray shown in FIG. 1;

FIG. 3 is a sectional plan view of a recording/reproducing apparatus showing a state in which the open/close door shown in FIG. 2is in a closed position;

FIG. 4 is an enlarged view of a recording/reproducing apparatus showing the vicinity of the open/close door shown in FIG. 3;

FIG. 5 is a sectional side view showing a state of operation of the open/close door due to tray movement, taken along the line A-A of FIG. 4;

FIG. 6 is a sectional side view showing a state of operation of the open/close door due to tray movement, taken along the line B-B of FIG. 4; and

FIG. 7 is a sectional side view showing a state of operation of the open/close door due to tray movement, taken along the line C-C of FIG. 4;

### DESCRIPTION OF THE PREFERRED EMBODIMENTS

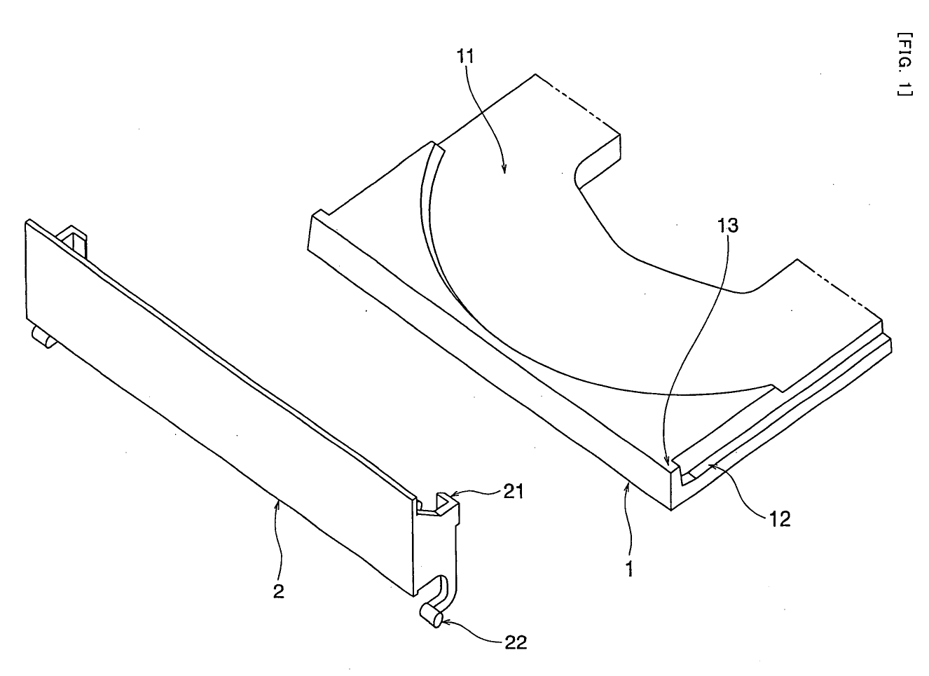

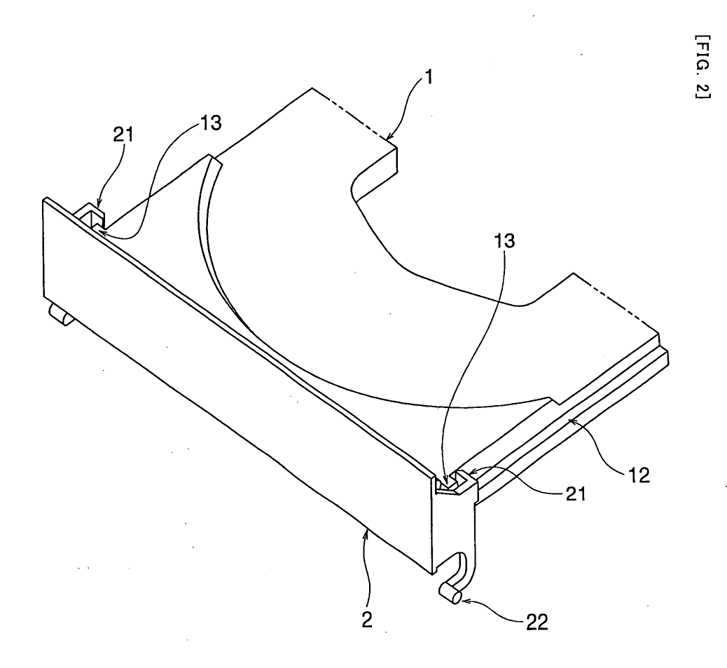

A structure of an open/close door and a tray of a recording/reproducing apparatus according to an embodiment of the present invention will be described with reference to FIGS. 1 to 3. FIG. 1 is a perspective view showing a tray 1 and an open/close door 2 before mounted on a casing; and FIG. 2 is a perspective view showing a state in which the tray 1 is engagingly fitted to the open/close door 2. The tray 1 includes: a storage medium placement face 11; a side face stepped portion 12 provided to be stepped on a side face of the tray 1; and a protrusion 13 provided at a front side end of the tray. On the other hand, the open/close door 2 includes an engaging rib 21 and a rotary shaft 22 at its back face.

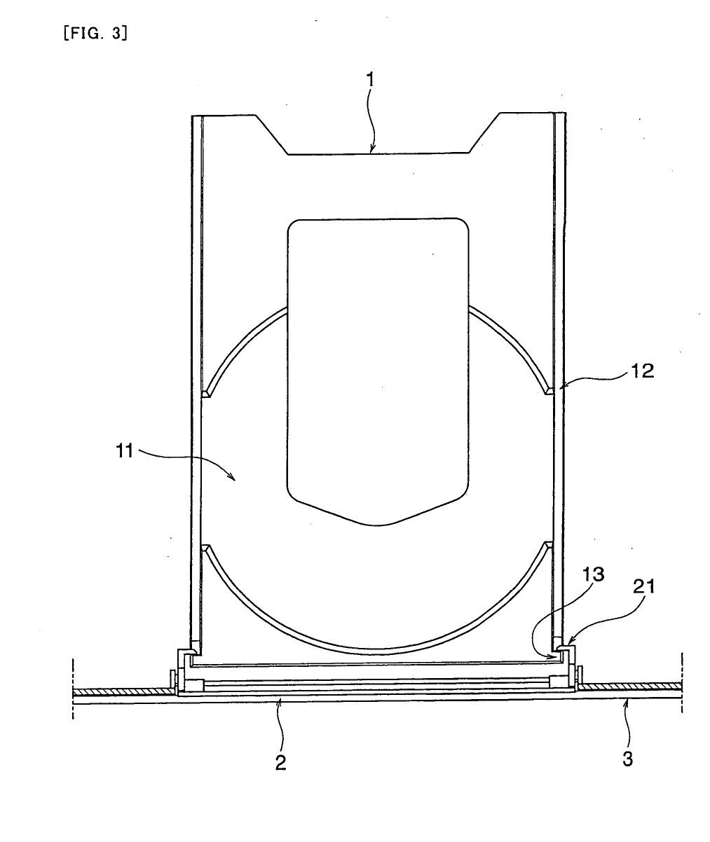

FIG. 3 is a sectional plan view of a recording/reproducing apparatus showing a state in which the open/close door 2 is at a closed position. The figure shows a state in which the tray 1 having the placement face 11 for placing a storage medium (not shown) is at a storage and/or reproduction position for setting the storage medium (not shown) at the reproduction position. In the state, the open/close door 2 pivotably fixed to a bearing portion described later, of a casing 3 via the rotary shaft 22, is at a closed position so that the engaging rib 21 provided at the open/close door 2 and the protrusion 13 provided at the front side end of the tray 1 are engaged with each other at the closed position of the open/close door 2.

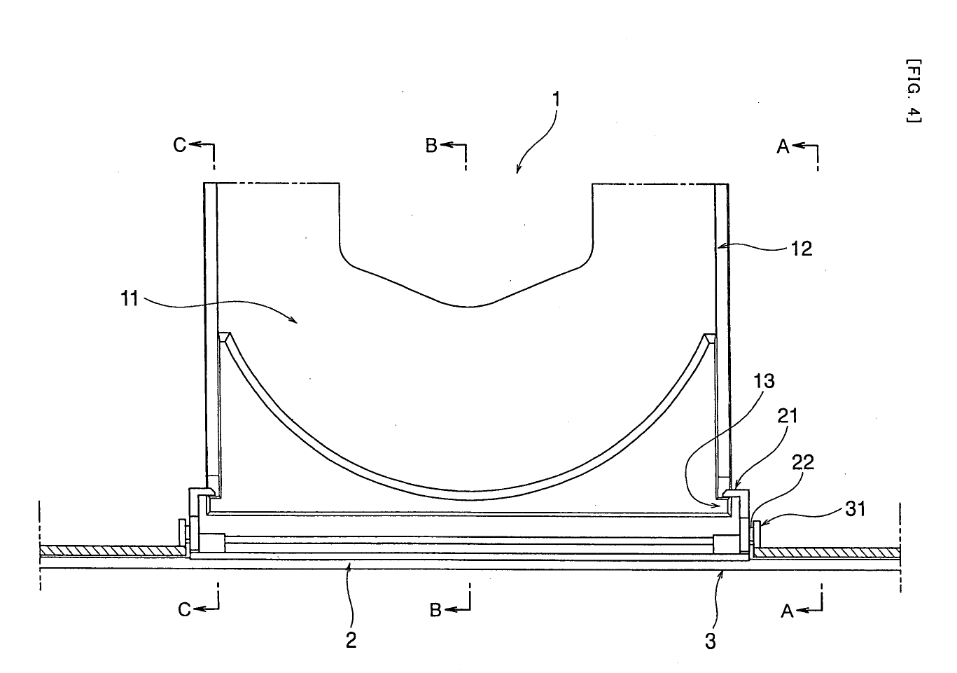

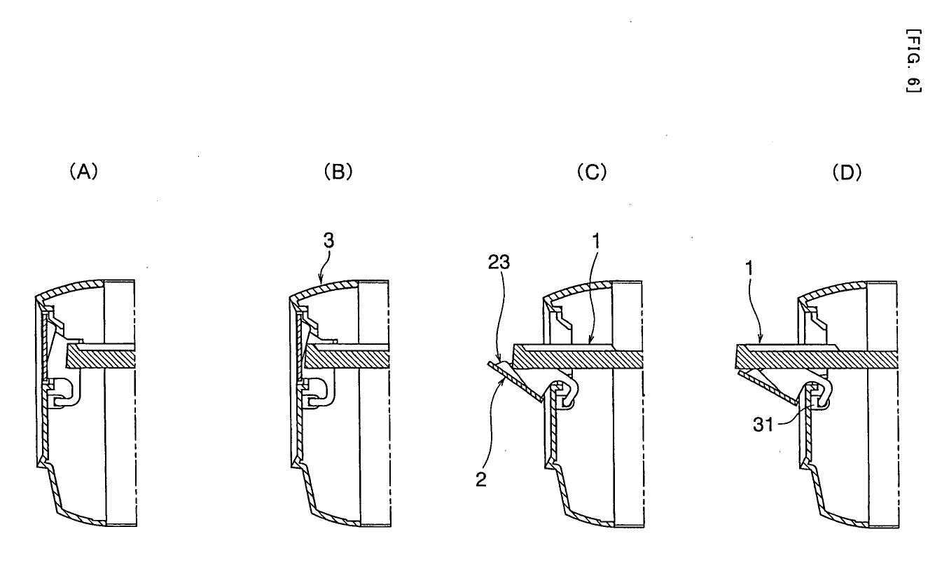

Now, an operation of an open/close door and a tray of a recording/reproducing apparatus according to an embodiment of the present invention will be described with reference to FIGS. 4 to 7. FIG. 4 is an enlarged view of a recording/reproducing apparatus showing the vicinity of the open/close door 2 shown in FIG. 3. The tray 1 includes: a placement face 11 for carrying a storage medium (not shown hereinafter); a side face stepped portion 12 provided at a side face of the tray 1, for guiding reciprocating movement of the tray 1 driven by a driver device (not shown); and a protrusion 13 provided at the front side end of the tray 1 in order to restrict opening and closing operation of the open/close door 2 when the open/close door 2 is at a closed position while it is engaged with an after-mentioned engaging rib 21 provided at the open/close door 2.

On the other hand, the open/close door 2 includes: the engaging rib 21 engaged with the protrusion 13 formed at the front side end of the tray 1 at its back face to maintain the closed position of the open/close door 2; a rotary shaft 22 for enabling the open/close door 2 to be pivoted between its closed position and open position; and an after-mentioned tray guide rib provided at the back face of the open/close door 2 in order to guide the open/close door 2 together with reciprocating movement of the tray 1, the tray guide rib being engaged with an outer end of the tray 1. In addition, a spring (not shown) for always biasing the open/close door 2 at the closed position direction is wound around the rotary shaft 22 of the open/close door 2, and the open/close door 2 is always restored at the closed position. Further, a bearing portion 31 corresponding to the rotary shaft 22 of the open/close door 2 is provided in the casing 3, and the rotary shaft 22 of the open/close door 2 is engaged with the bearing portion 31, and thereby the open/close door 2 is fixed to the casing 3 in a pivotable state.

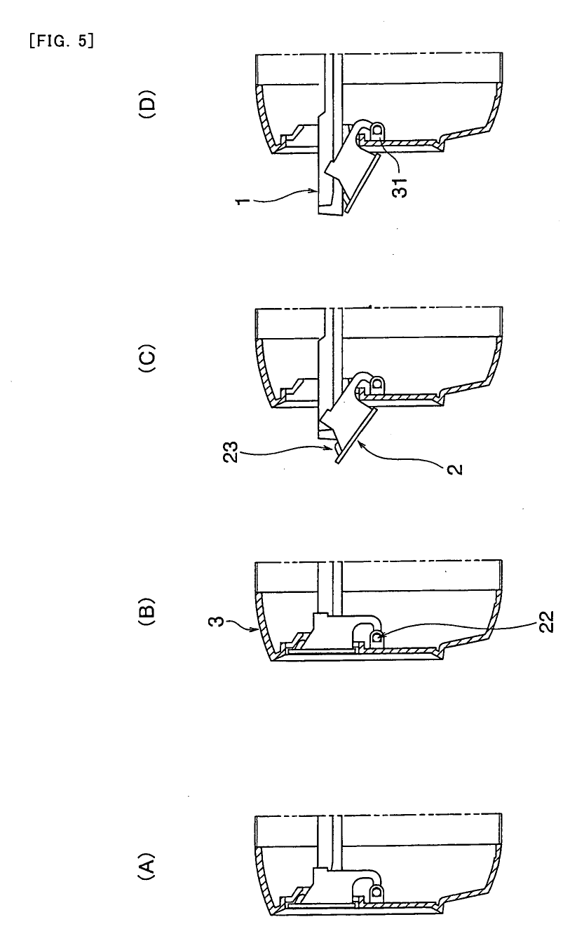

FIGS. 5, 6, and 7 each are sectional side views of a recording/reproducing apparatus showing a state of operation of the open/close door 2 together with advancing and retracting movements of the tray 1 viewed from cross sections taken along the lines A-A, B-B, and C-C shown in FIG. 4. FIGS. 5 (A), 6 (A), and 7 (A) each show a state in which the tray 1 is set at a storage and/or reproduction position of a storage medium (not shown), and the open/close door 2 is in the closed state. On the other hand, FIGS. 5 (D), 6 (D), and 7 (D) each show a state in which the open/close door 2 is at an open position in a state in which the tray 1 is being transported.

Now, an opening/closing operation of the open/close door 2 together with reciprocating movement of the tray 1 will be described with reference to FIGS. 5 to 7. In addition, a description will be given with respect to an operation of the tray 1 and the open/close door 2 from a state in which the tray 1 is at a storage medium exchange position in order to mount and remove a storage medium (not shown) outside of the casing 3, i.e., a state in which the open/close door 2 is at the open position (FIGS. 5 (D), 6 (D), and 7 (D)) to a state in which the tray 1 is stored at the storage and/or reproduction position inside of the casing 3 after mounting and removing the storage medium (not shown), i.e., a state in which the open/close door 2 is at the closed position (FIGS. 5 (A) 6 (A), and 7 (A)).

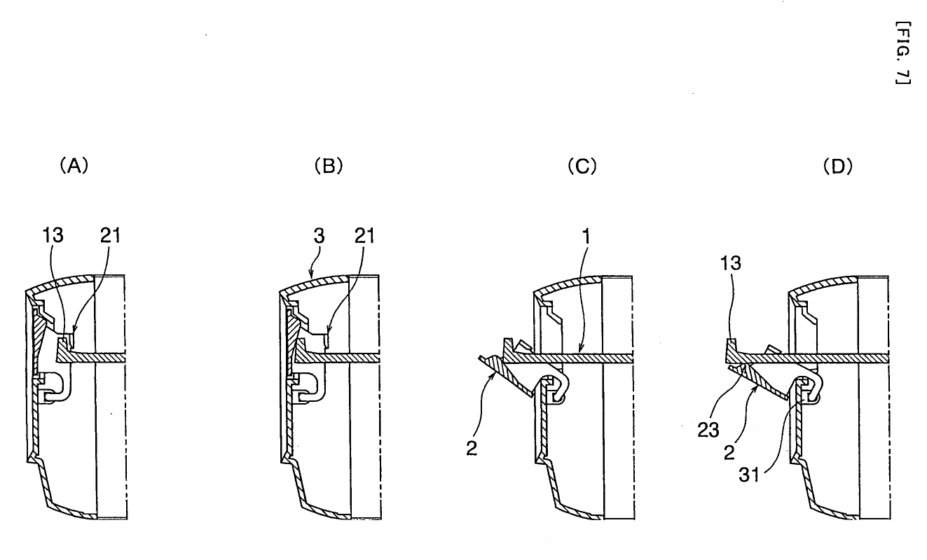

FIG. 7 (D) shows a state in which the tray 1 is being transported to mount and remove the storage medium (not shown) outside the casing 3, i.e., a state in which the open/close door 2 is at the open position. A force of always restoring the open/close door 2 at the closed position is biased by means of a spring (not shown) wound around the rotary shaft 22. However, in the state shown in FIG. 7 (D), a bottom face of the tray 1 is engaged with a tray guide rib 23 provided on the back face of the open/close door 2, thus maintaining the shown state.

In a state in which the tray 1 is at the storage medium exchange position, after a storage medium (not shown) has been mounted on and removed from the placement face 11 on the tray 1, the tray 1 is slightly pushed by fingers or an open/close switch provided at the recording/reproducing apparatus is pressed, and thereby a driver device (not shown) is driven, and then, the tray 1 starts retracting toward the storage and/or reproduction position inside of the casing 3, as shown in FIG. 7 (D). The tray 1 retracts along the tray guide rib 23 provided on the back face of the open/close door 2, and the tray 1 continues engagement with the tray guide rib 23 until the open/close door 2 reaches the closed position. That is, the open/close door 2 maintains the state shown in FIG. 7 (D). From the state shown in FIG. 7 (C) in which the bottom face of the tray 1 and the guide rib 23 are disengaged from each other, pivoting movement with the rotary shaft 22 being a support shaft is gradually started by a biasing force of a spring.

FIG. 7 (B) shows a state in which the open/close door 2 has reached the closed position. At this stage, engagement between a tip end portion of the tray 1 and the tray guide rib 23 is continued, while the open/close door 2 is pivoted at the closed position by means of the spring (not shown). Then, part of the open/close door 2 abuts against a wall portion formed in the casing 3, and the open/close door 2 is restricted so as not to enable pivoting toward the inside of the casing 3 any more.

When the tray 1 further continues retracting, and reaches the storage and/or reproduction position, driving of the driver device (not shown) terminates. As shown in FIG. 7 (A), the tray 1 stops retracting operation. At the storage and/or reproduction position of the storage medium (not shown), the engaging rib 21 provided on the back face of the open/close door 2 is engaged with the protrusion 13 provided at the front side end of the tray 1, and thereby, even if a stress exceeding the biasing force of the spring (not shown) is applied in a direction in which the open/close door 2 is opened from the outside of the recording/reproducing apparatus, the open/close door 2 can continue to be engaged with the tray 1. In addition, as shown in FIG. 5, the engaging rib 21 provided at the open/close door 2 is moved together with reciprocating movement of the tray 1 along the side face stepped portion 12 provided on the side face of the tray 1, for guiding reciprocating movement of the tray 1 driven by means of the driver device (not shown), and thereby pivoting movement for the open/close door 2 to reach the closed position (FIG. 5 (A)) from the open position (FIG. 5 (D)) can be smoothened without any shaking.

Now, a description will be given with respect to an operation of the tray 1 and the open/close door 2 when the tray 1 set at the storage and/or reproduction position inside of the casing 3 shown in FIG. 7 (A) is advanced to enter the state of the storage medium exchange position outside of the casing 3 in order to mount and remove a storage medium (not shown).

FIG. 7 (A) shows a state in which the tray 1 is at the storage and/or reproduction position, that is, a state in which the open/close door 2 is at the closed position regardless of whether or not the storage medium (not shown) is placed on the placement face 11. In this state, as described above, the engaging rib 21 provided at the back face of the open/close door 2 is engaged with the protrusion 13 provided at the front side end of the tray 1, and thereby, even if a stress exceeding the biasing force of the spring (not shown) is applied in a direction in which the open/close door 2 is opened from the outside, the open/close door 2 can be maintained in a state engagingly fitted to the tray 1.

Here, in the case where a command for advancing the tray 1 to the outside of the casing 3 is supplied in order to mount and remove a storage medium (not shown) by pressing a remote control (not shown) or an open/close switch or the like provided at the recording/reproducing apparatus, a driver device (not shown) is driven, and, as shown in FIG. 7 (B), the tray 1 starts advancing toward a direction of the storage medium exchange position outside of the casing 3. The open/close door 2 is designed so as to always maintain the closed position by means of the biasing force of the spring (not shown) and thus, the open/close door 2 is maintained at the closed position.

The tray 1 further continues advancing by means of the driving force of the driver device (not shown) the protrusion 13 provided at the front side end of the tray 1 abuts against the tray guide rib 23 provided on the back face of the open/close door 2; and, as shown in FIG. 7 (C), the open/close door 2 starts pivoting from the closed position to the open position by the driving force of the driver device (not shown) exceeding the biasing force of the spring (not shown) while the rotary shaft 22 is used as a support shaft. The tray 1 advances along the tray guide rib 23 provided at the back face of the open/close door 2, and the tray 1 continues engagement with the tray guide rib 23 until the open/close door 2 reaches the open position. Thus, the open/close door 2 gradually continues pivoting movement with the rotary shaft 22 being a support shaft toward an open position direction while the state shown in FIG. 7 (D) is maintained.

When the tray 1 further continues advancing and reaches the storage medium exchange position, driving of the driver device (not shown) stops, thereby the tray 1 stops advancing operation. As shown in FIG. 5, the engaging rib 21 provided at the open/close door 2 is moved together with reciprocating movement of the tray 1 along the side face stepped portion 12 provided on the side face of the tray 1, for guiding reciprocating movement of the tray 1 driven by means of the driver device (not shown), and thereby pivoting movement for the open/close door 2 to reach the open position (FIG. 5 (D)) from the closed position (FIG. 5 (A)) can be smoothened without any shaking.

In the foregoing embodiment, a description has been given by way of example of a mechanism for engaging the protrusion 13 provided at the front side end of the tray 1 with the tray guide rib 23 provided on the back face of the open/close door 2 in order to cause advancing and retracting movements of the open/close door 2 to move with reciprocating movement of the tray 1. Without being limited to this mechanism, for example, it is possible to provide a mechanism for abutting an engagement piece integrally formed at a side portion of the tray against a pin provided at an end of an arm which is turnable together with the open/close door, as disclosed in Japanese Utility Model Registration 3069866. In the case of employing a mechanism for making reciprocating movement of the tray and opening/closing operation of the open/close door together according to Japanese Utility Model Registration 3069866 as well, by providing a mechanism for engaging the engaging rib 21 provided on the back face of the open/close door 2 with the protrusion 13 provided at the front side end of the tray 1 according to the present invention, it is possible to maintain the closed position of the open/close door 2 even if a stress exceeding the biasing force of the spring (not shown) is applied in a direction in which the open/close door 2 is opened from the outside. In addition, there is no need for a mechanism which requires complicated operation as disclosed in Japanese Utility Model Registration 3069866, and an increased number of parts can be avoided.

1. A tray-equipped recording/reproducing apparatus comprising:
a tray for transporting a storage medium between a storage and/or reproduction position inside of the apparatus and a storage medium exchange position outside of the apparatus;
a casing having an opening portion on a transport passage of the tray; and
an open/close door pivotably provided at the opening portion of the casing, the open/close door enabled to open or shut together with the transporting operation of the tray,
wherein engagement means engaged with an outward end of the tray is provided at a rear side of the open/close door.

2. The tray-equipped recording/reproducing apparatus according to claim 1, wherein, at the front side end of the tray, a protrusion engaged with the engagement means of the open/close door is formed to be protruded in a widthwise direction of the tray.

3. The tray-equipped recording/reproducing apparatus according to claim 1, wherein, at a side end of the tray, a guide groove for guiding the engagement means of the open/close door together with the transporting operation of the tray is formed in the transport direction of the tray.

4. The tray-equipped recording/reproducing apparatus according to claim 1, wherein the engagement means of the open/close door is constructed to integrally form a support portion which extends from the rear face of the open/close door and a claw portion protruded inwardly of the open/close door from a tip end of the support portion.

5. The tray-equipped recording/reproducing apparatus according to claim 1, wherein, in a state in which the tray is transported to the storage and/or reproduction position inside the apparatus, the tray and the engagement means provided at the open/close door are engaged with each other to restrict an opening operation of the open/close door.

6. The tray-equipped recording/reproducing apparatus according to claim 2, wherein, at a side end of the tray, a guide groove for guiding the engagement means of the open/close door together with the transporting operation of the tray is formed in the transport direction of the tray.

7. The tray-equipped recording/reproducing apparatus according to claim 2, wherein the engagement means of the open/close door is constructed to integrally form a support portion which extends from the rear face of the open/close door and a claw portion protruded inwardly of the open/close door from a tip end of the support portion.

8. The tray-equipped recording/reproducing apparatus according to claim 3, wherein the engagement means of the open/close door is constructed to integrally form a support portion which extends from the rear face of the open/close door and a claw portion protruded inwardly of the open/close door from a tip end of the support portion.

9. The tray-equipped recording/reproducing apparatus according to claim 6, wherein the engagement means of the open/close door is constructed to integrally form a support portion which extends from the rear face of the open/close door and a claw portion protruded inwardly of the open/close door from a tip end of the support portion.

10. The tray-equipped recording/reproducing apparatus according to claim 2, wherein, in a state in which the tray is transported to the storage and/or reproduction position inside the apparatus, the tray and the engagement means provided at the open/close door are engaged with each other to restrict an opening operation of the open/close door.

11. The tray-equipped recording/reproducing apparatus according to claim 3, wherein, in a state in which the tray is transported to the storage and/or reproduction position inside the apparatus, the tray and the engagement means provided at the open/close door are engaged with each other to restrict an opening operation of the open/close door.

12. The tray-equipped recording/reproducing apparatus according to claim 6, wherein, in a state in which the tray is transported to the storage and/or reproduction position inside the apparatus, the tray and the engagement means provided at the open/close door are engaged with each other to restrict an opening operation of the open/close door.

13. The tray-equipped recording/reproducing apparatus according to claim 4, wherein, in a state in which the tray is transported to the storage and/or reproduction position inside the apparatus, the tray and the engagement means provided at the open/close door are engaged with each other to restrict an opening operation of the open/close door.

14. The tray-equipped recording/reproducing apparatus according to claim 7, wherein, in a state in which the tray is transported to the storage and/or reproduction position inside the apparatus, the tray and the engagement means provided at the open/close door are engaged with each other to restrict an opening operation of the open/close door.

15. The tray-equipped recording/reproducing apparatus according to claim 8, wherein, in a state in which the tray is transported to the storage and/or reproduction position inside the apparatus, the tray and the engagement means provided at the open/close door are engaged with each other to restrict an opening operation of the open/close door.

16. The tray-equipped recording/reproducing apparatus according to claim 9, wherein, in a state in which the tray is transported to the storage and/or reproduction position inside the apparatus, the tray and the engagement means provided at the open/close door are engaged with each other to restrict an opening operation of the open/close door.
